(19) United States
(12) Patent Application Publication
(10) Pub. No.: US 2011/0056048 A1
(43) Pub. Date: Mar. 10, 2011

(54) HINGE

(75) Inventor: WEN-BIN SHEN, Tu-Cheng (TW)

(73) Assignee: HON HAI PRECISION INDUSTRY CO., LTD., Tu-Cheng (TW)

(21) Appl. No.: 12/562,154

(22) Filed: Sep. 18, 2009

(30) Foreign Application Priority Data
Sep. 10, 2009 (CN) 200920310044.9

(51) Int. Cl. E05D 11/08

(52) U.S. Cl. 16/342

(57) ABSTRACT

A hinge includes a connecting member, a shaft fixed to the connecting member, a rotating member, and a friction member. The shaft includes a shaft body. The rotating member is rotatably mounted to the shaft body. The rotating member includes a first side, and a second side opposite to the first side. The friction member is unrotatably mounted to the shaft body, and one side of the friction member abutting the rotating member. A number of posts protrude from one of the first side, the second side, or the side of the friction member abutting the rotating member.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at any angle with respect to the main body. During rotation, friction between the first and second elements may be too much to damage the first and the second elements. Therefore, the first and second elements are easy worn after frequent usage, resulting in preventing the cover from being able to stay at certain desirable positions, which creates quite an inconvenience for users.

### BRIEF DESCRIPTION OF THE DRAWINGS

FIG. 1 is an exploded, isometric view of an exemplary embodiment of a hinge.

FIG. 2 is similar to FIG. 1, but viewed from another perspective.

FIG. 3 is an assembled, isometric view of the hinge of FIG. 1.

FIG. 4 is an assembled, isometric view of the hinge of FIG. 2.

### DETAILED DESCRIPTION

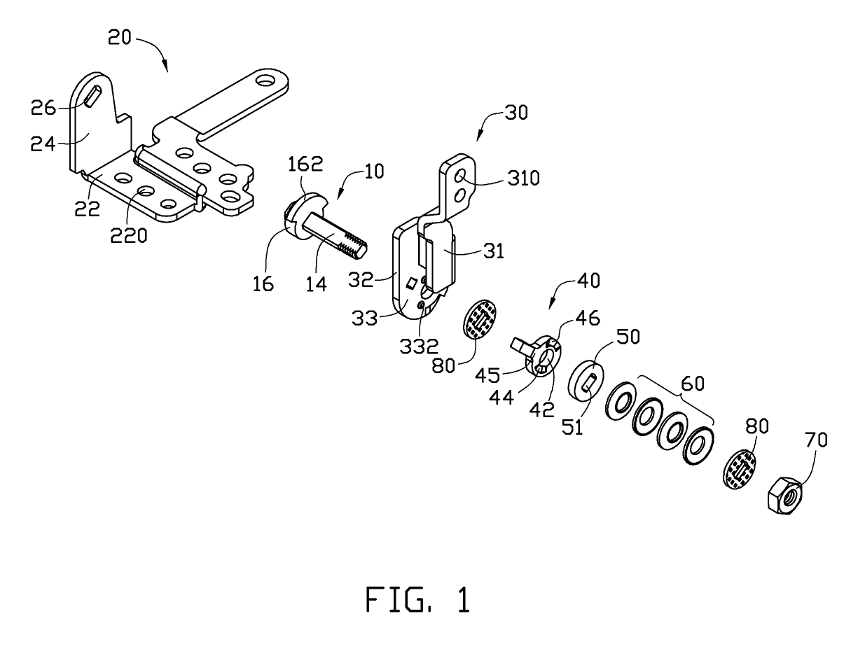

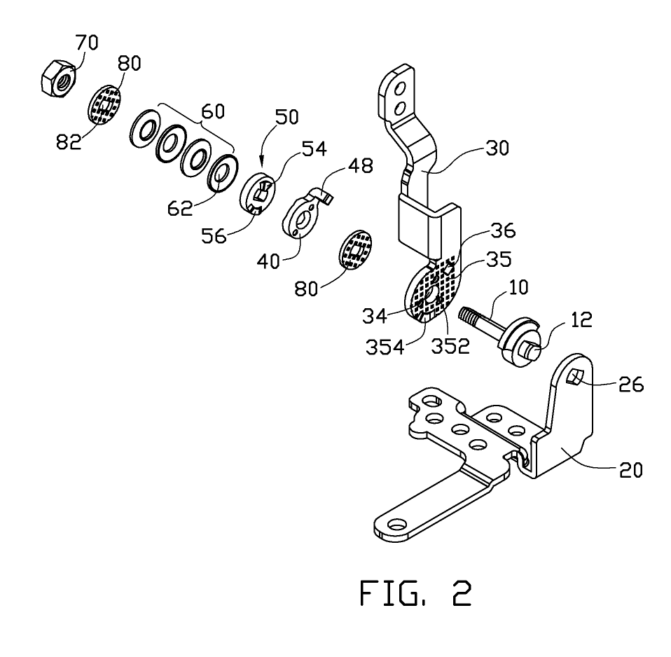

Referring to FIGS. 1 and 2, an exemplary embodiment of a hinge includes a shaft 10, a connecting member 20, a rotating member 30, a first interfering member 40, a second interfering member 50, a plurality of elastic rings 60, a fastener 70, and two friction members 80. In the embodiment, the fastener 70 is a nut.

The shaft 10 includes a fixing portion 12, a shaft body 14, and a resisting portion 16 connected between the fixing portion 12 and the shaft body 14. The fixing portion 12 has a double-D shaped cross-section for being fixed to the connecting member 20. The shaft body 14 has a double-D shaped cross-section, and forms a threaded portion (not labeled) on a circumference of a distal end of the shaft body 14, for engaging with the fastener 70. A cambered resisting protrusion 162 protrudes from a circumference of the resisting portion 16.

The connecting member 20 includes a connecting board 22 defining a plurality of fixing holes 220, and a fixing board 24 perpendicularly extending from a side of the connecting board 22. The fixing board 24 defines a fixing hole 26 having a double-D shape, corresponding to the fixing portion 12 of the shaft 10, for fixing the shaft 10 to the connecting member 20.

The rotating member 30 includes a fixing body 31 defining a plurality of fixing holes 310, and a pivoting portion 32 parallel connected to the fixing body 31. The pivoting portion 32 includes a first side 33 and a second side 35 opposite to the first side 33. The pivoting portion 32 defines a through hole 34 and a fixing hole 36. The through hole 34 extends through the first and second sides 33 and 35, for allowing the shaft body 14 to rotatably pass therethrough. At least three posts 332 extend from the first side 33, around the through hole 34. Correspondingly, at least three dents 352 are defined in the second side 35, thereby, resulting in reducing a contacting surface between the resisting portion 16 of the shaft 10 and the second side 35. A wedge-shaped resisting block 354 protrudes out from the second side 35, along an edge of the pivoting portion 32. One end of the second resisting block 354 is smoothly and slantingly connected to the second side 35.

The first interfering member 40 defines a round hole 42 therein, for allowing the shaft body 14 of the shaft 10 to rotatably pass therethrough. The first interfering member 40 includes a matching side 45 opposite to the first side 33 of the rotating member 30. A first depressed portion 44 and a second depressed portion 46 are defined in the matching side 45, opposite each other across the round hole 42. The first depressed portion 44 extends along a cambered edge of the round hole 42, and the second depressed portion 46 extends along an edge of the first interfering member 40. A fixing post 48 axially extends inverse of the matching side 45 from the first interfering member 40.

The second interfering member 50 is generally washer-shaped, and defines a matching hole 51 having a double-D shape, corresponding to the shaft body 14 of the shaft 10, for unrotatably fitting about the shaft body 14 of the shaft 10. A first protrusion 54 and a second protrusion 56 extend from the second interfering member 50, opposite each other across the matching hole 51. The first protrusion 54 extends along an edge of the matching hole 51, and the second protrusion 56 extends adjacent to a circumference of the second interfering member 50.

Each elastic ring 60 provides elasticity along an axial direction of the shaft 10, to tighten the rotating member 30, both of the first and second interfering members 40 and 50, and one of the friction members 80. Each elastic ring 60 defines a round through hole 62, allowing the shaft body 14 of the shaft 10 to rotatably pass therethrough.

Each friction member 80 defines a double-D shaped fixing hole 82, for unrotatably receiving the shaft body 14 of the shaft 10.

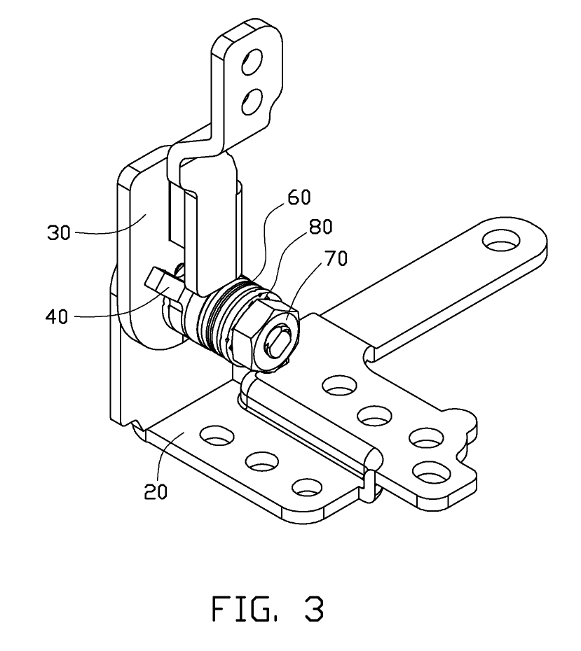

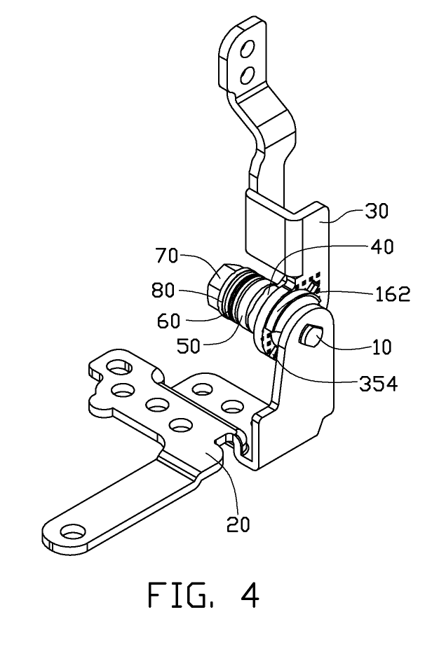

Referring to FIGS. 3 and 4, in assembly, the fixing portion 12 of the shaft 10 is fixedly received in the fixing hole 26 of the connecting member 20, therefore, the shaft 10 is fixed to the connecting member 20. The shaft body 14 of the shaft 10 is passed through the through hole 34 of the rotating member 30, the fixing hole 82 of one of the friction members 80, the round hole 42 of the first interfering member 40, the matching hole 51 of the second interfering member 50, the through holes 62 of the plurality of elastic rings 60, and the fixing hole 82 of the other friction member 80 one by one in that order, with the distal end of the shaft body 14 engaging in the fastener 70 for preventing the rotating member 30, the first and second interfering members 40 and 50, the friction members 80, and the plurality of elastic rings 60 from disengaging from the shaft 10.

In the aforementioned assembly, the fixing post 48 of the first interfering member 40 is fixed in the fixing hole 36 of the rotating member 30, therefore, the first interfering member 40 is rotated with the rotating member 30. The first and second protrusions 54 and 56 of the second interfering member 50 are engaged in the first and second depressed portions 44 and 46 of the first interfering member 40, respectively. The at least three posts 332 of the rotating member 30 resist against the corresponding friction member 80, which results in reducing a friction force between the friction member 80 and the rotating member 30

In use, the connecting member 20 is fixed to one of a cover and a base of a collapsible device (not shown), via the plurality of fixing holes 220, and the rotating member 30 is fixed to the other one of the cover and the base of the collapsible device, via the plurality of fixing holes 310. Therefore, during rotation of the cover relative to the base, the rotating member 30 rotates relative to the connecting member 20, together with the first interfering member 40. As a result, the at least three posts 332 of the rotating member 30 slide on a corresponding side abutting the rotating member 30 of the friction member 80. In the meanwhile, the first and second protrusions 54 and 56 of the second interfering member 50 are moved onto the matching side 45 of the first interfering member 40, or into the first and second depressed portions 44 and 46 of the first interfering member 40, respectively. When the rotating member 30 is rotated to a predetermined degree relative to the connecting member 20, the resisting block 354 of the rotating member 30 resists against the resisting protrusion 162 of the shaft 10. Therefore, the rotating member 30 cannot be rotated further relative to the connecting member 20. As a result, the cover is stably maintained at the predetermined degree with respect to the base resulting preventing the cover from over-rotating.

Obviously, in one embodiment, the at least three posts 332 also can protrude from the second side 35 of the rotating member 30, and resist against the resisting portion 16 of the shaft 10. In another embodiment, the at least posts 332 also can extend from the side abutting the rotating member 30 of one of the friction member 80.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a connecting member;
a shaft fixed to the connecting member, and comprising a shaft body;
a rotating member rotatably mounted to the shaft body, the rotating member comprising a first side, and a second side opposite to the first side; and
a friction member unrotatably mounted to the shaft body, and one side of the friction member abutting the rotating member;
wherein a plurality of posts protrude from one of the first side, the second side, or the side of the friction member abutting the rotating member.

2. The hinge of claim 1, wherein the rotating member defines a through hole, through which the shaft body is freely passed.

3. The hinge of claim 2, wherein the plurality of posts extend from the first side and around the through hole, and resist against the side of the friction member.

4. The hinge of claim 3, wherein the shaft further comprises a resisting portion abutting the second side of the rotating member, the second side defines a plurality of dents aligned with the plurality of posts.

5. The hinge of claim 1, further comprising a first interfering member fixed to the rotating member, wherein the friction member is sandwiched between the first interfering member and the rotating member.

6. The hinge of claim 5, wherein the rotating member defines a fixing hole; a fixing post extends from the first interfering member, and is fixedly engaged in the fixing hole of the rotating member.

7. The hinge of claim 5, further comprising a second interfering member, wherein the first interfering member comprises a matching side opposite to the friction member, the matching side defines a first depressed portion and a second depressed portion, a first protrusion and a second protrusion extend from the second interfering member, and are engaged in the first and second depressed portions, respectively.

8. The hinge of claim 1, wherein the shaft further comprises a resisting portion resisting against the second side of the rotating member, a resisting block protrudes out from the second side, a resisting protrusion protrudes from a circumference of the resisting portion, to resist against the resisting block.

9. A hinge comprising:
a connecting member;
a shaft fixed to the connecting member, and comprising a shaft body;
a rotating member rotatably mounted to the shaft body, the rotating member comprising a first side, at least three posts extending from the first side;
a friction member unrotatably mounted to the shaft body and resisting against the at least three posts;
a first interfering member fixed to the rotating member and rotatably mounted on the shaft, a first depressed portion and a second depressed portion both defined in the first interfering member; and
a second interfering member fixedly mounted to the shaft body, a first protrusion and a second protrusion extending from the second interfering member, and engaged in the first and second depressed portions, respectively;
wherein during rotation of the rotating member relative to the connecting member, the first and second protrusions are correspondingly slid out of or into the first and second depressed portions, the at least three posts are slid on a corresponding side of the friction member.

10. The hinge of claim 9, wherein the shaft further comprises a resisting portion, the rotating member further comprises a second side opposite to the first side, the second side abuts the resisting portion, and defines a plurality of dents aligned with the posts.

11. The hinge of claim 10, wherein a resisting block protrudes out from the second side, a resisting protrusion protrudes from a circumference of the resisting portion, to resist against the resisting block.

12. The hinge of claim 9, wherein the rotating member defines a fixing hole, a fixing post extends from the first interfering member, and is fixedly engaged in the fixing hole of the rotating member.

13. The hinge of claim 9, wherein the first interfering member abuts the friction member, and defines a round hole, through which the shaft body is rotatably passed, the first depressed portion extends along a cambered edge of the round hole, and the second depressed portion extends along an edge of the first interfering member.

14. The hinge of claim 9, wherein the second interfering member defines a matching hole for being fixedly engaged with the shaft body, the first protrusion extends along an edge of the matching hole, and the second protrusion extends adjacent to a circumference of the second interfering member.
